(19) United States
(12) Patent Application Publication
(10) Pub. No.: US 2016/0239630 A1
(43) Pub. Date: Aug. 18, 2016

(54) METHOD FOR PROVIDING MEDICAL INFORMATION

(71) Applicant: BBB INC., Seongnam-si (KR)

(72) Inventors: Jaekyu CHOI, Seongnam-si (KR); Kyongsik YUN, Seongnam-si (KR)

(21) Appl. No.: 14/849,539

(22) Filed: Sep. 9, 2015

(30) Foreign Application Priority Data
Feb. 13, 2015 (KR) 10-2015-0022317

(51) Int. Cl. G06F 19/00

(52) U.S. Cl. CPC G06F 19/3431

(57) ABSTRACT

The present disclosure relates to a phase of receipt for receiving the user information and the result of the health diagnosis regarding the user, wherein the results of the health diagnosis regarding the user includes the numeric result value(s) regarding at least one medical checkup item; a phase that decides the risk group in which the user belongs among multiple risk groups by basing on the user information, a phase that decides the risk group in which the user belongs with the multiple risk group categorized according to the degree of the danger predicted regarding the health; and, a phase for deriving medical information related to the user that includes the health risk rating by considering the risk group in which the user belongs and the result of the health diagnosis regarding the user.

### CROSS-REFERENCE TO RELATED APPLICATION

This application claims the priority of the Korean Patent Application No. 10-2015-0022317, filed on Feb. 13, 2015 in the Korean Intellectual Property Office (KIPO), and all the benefits accruing therefrom under 35 U.S.C. §119, the contents of which in their entirety are herein incorporated by reference.

### TECHNICAL FIELD

The present invention relates to a method for providing medical information, and more particularly, a method for providing medical information that includes a health hazard rating that can be easily understood by a user.

### BACKGROUND ART

Due to the increase of the average lifespan of human beings, the interest in health has been rapidly increasing. As a result, the healthcare industry has been receiving the spotlight. Currently, various mechanisms providing health care services have already been developed, or the development is underway. Furthermore, the current trend is for existing mechanisms to be also improved in a user-friendly manner.

The blood analyzer can be touted as a representative example of healthcare equipment, and there has been a continuous research & development in this field since useful information can be derived from analyzing humans' blood. Specifically, existing blood analyzers can display the measurement result of the blood by displaying the information on the concerned equipment, and is equipped with a user interface that can print the measurement result according to the need.

### DISCLOSURE OF INVENTION

### Technical Problem

However, regarding the information, the blood analyzer merely provides an objective and numerical value that is popularly used in medical circles like the total cholesterol (TC) figures or the high-density lipoprotein (HDL) cholesterol figures. Consequently, in order to derive useful information regarding the health of the user from the analysis value of the blood analyzer, the user, for example, needs to understand the guideline regarding cholesterol figures, such as the ATP III guideline. Except, it is difficult for a non-expert user to understand such guidelines because of the guideline is drafted in a complicated manner and includes difficult technical terms. As such, there are limited measures for ordinary people to obtain useful medical information without going to professional organizations, including hospitals and etc.

As a result, there is an urgent need to develop a technology that can convert health diagnosis results such as the analysis value from blood analyzer tests so that non-experts can also easily understand the information, and thus popularize the medical information.

According to one aspect of the present invention for achieving the above mentioned purpose, a method for providing the medical information is provided, that can derive the health hazard rating that can be easily understood by the ordinary people by receiving the result of the health diagnosis.

According to another aspect of the present invention for achieving the above mentioned purpose, a method for providing medical information is provided, that can derive an integrated health hazard rating that can be understood by the ordinary people even if the result of the health diagnoses includes numerical values regarding multiple medical checkups.

According to yet another aspect of the present invention for achieving the above mentioned purpose, a method for providing medical information is provided, that can offer predictions regarding the future condition of the user and recommendations for the recovery of the health of the user, instead of providing merely fragmented information regarding the present condition.

The foregoing is illustrative of technical problems of the present invention, and should not be construed as limited to technical problems set forth herein. Rather, contents described hereinbelow shall allow those skilled in the art to fully understand other technical problems that have not been described herein.

### Effects of The Invention

While the present invention has effects that will be described more fully hereinafter, it is to be understood that the effect of the present invention is not limited thereto.

First, according to the present invention, useful medical information which can be easily understood by non-experts may be provided by deriving medical information that includes the health hazard rating by using the results of the health diagnoses.

Second, according to the present invention, useful information can be effectively provided to the user, including predictions regarding the future condition of the user and recommendations for the recovery of the health of the user, instead of merely providing fragmented information regarding the present condition by using the result of the health diagnoses. As such, the user can accurately understand his or her health condition and cope with the result.

### BRIEF DESCRIPTION OF DRAWINGS

FIG. 1 is a diagram illustrating a rough composition of a system providing medical information according to the exemplary embodiment of the present invention.

FIG. 2 is a flow chart illustrating a method for providing medical information according to the exemplary embodiment of the present invention.

FIG. 3 is a table related to the target value of the LDL cholesterol.

FIG. 4 is a flow chart that has materialized the phase S30 of the FIG. 2.

FIG. 5 is a table related to the target value of the total cholesterol and the HDL cholesterol.

### DETAILED DESCRIPTION OF THE INVENTION

A desirable exemplary embodiment of the present invention will be described in detail hereinafter in reference with the accompanied drawings. The advantage and characteristic, and a method to achieve them will be obvious upon detailed description of the exemplary embodiments as well as accompanied drawings which follow. However, the present invention is not limited to the exemplary embodiments set forth herein, but can be embodied in many different forms. The exemplary embodiments are provided only to render the present disclosure complete and the scope of the present invention comprehensible to those having ordinary skill in the art. The present invention is only to be defined by the claims. A same reference mark used refers to a same element throughout the description.

Without separate definitions, all terms (including technical and scientific terms) used in the present description may be used for the meanings commonly understandable to those having ordinary skill in the art. In addition, the terms generally used and having definitions in dictionary, unless otherwise defined obviously in particular, should not be ideally or exaggeratedly interpreted.

The terms used in the present description are to explain the exemplary embodiments, not to limit the present invention thereto. In the present description, a singular form of word also includes a plural form thereof unless otherwise noted. The term “comprises” and/or “comprising” is not excluding the meaning that one or more elements other than the said element may exist or be added.

While the specification explains the provision of the medical information related to the cholesterol value based on the ATP III Guideline for the convenience of the explanation, it will be understood that the present invention is not intended to be limited to the example shown.

A method for providing A method for providing medical information according to embodiments of the present invention will be described more fully hereinafter with reference to the accompanying drawings, in which embodiments of the invention are shown.

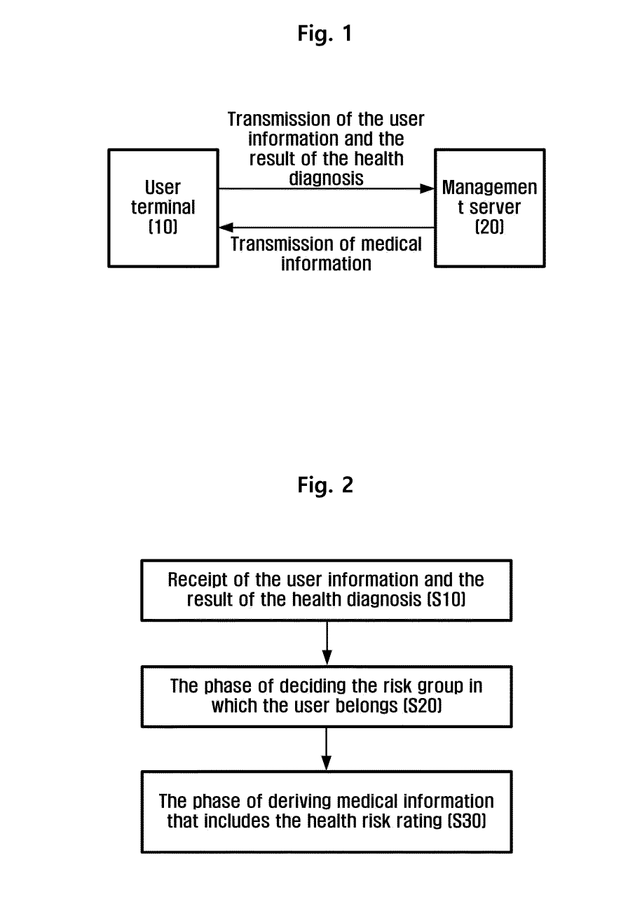

Except, for the efficient explanation of a method for providing medical information, prior explanations will be given regarding the system for providing medical information with which a method for providing medical information can be performed according to embodiments of the present invention. Referring to FIG. 1, a drawing that shows a rough composition of the system for providing medical information according to embodiments of the present invention is disclosed.

Referring to FIG. 1, a system for providing medical information may include the user terminal (10) and the management server (20). Except, as all of components shown in FIG. 1 may not be indispensable, a system for providing medical information described herein may include more components or fewer components than the components illustrated in FIG. 1.

According to a system for providing medical information according to embodiments of the present invention, the user information and the result of the health diagnoses can be transmitted from the user terminal (10) to the management server (20). And, based on the user information received and the result of the health diagnoses, the management server (20) can derive medical information related to the concerned user and can transmit the derived medical information to the user terminal (10). According to the system for providing medical information according to exemplary embodiment, the result of the health diagnoses, which require medical knowledge to interpret the information, can be provided to the user by converting to the medical information which can be understood by non-experts. As such, this can help users to easily understand the medical information.

Specifically, the user's terminal (10) can transmit the user information and the result of the health diagnoses to the management server (20).

The user information herein can mean the information regarding the user who uses the user terminals (10) or the information regarding principal users who intend to receive medical information by using the system for providing the medical information. Specifically, the user information can include objective user information and subjective user information. The objective user information is information that can be objectified without the judgment of the user being added. For example, it can include information of at least one of the following: he age, the height, the weight, the gender, the brainwave condition, the medical history, the family history, and the accumulated result of the health diagnoses, but is not limited thereto. The medical history may include the following: whether or not there has been a medical treatment of the cardiac disorder; whether or not there have been symptoms related to the cardiac disorder (chest pain, breathing difficulty, and etc.); whether or not there has been a peripheral blood disease; whether or not there has been the vesicular disease of the aorta, and etc., but the history is not limited thereto.

The subjective user information is information in which the judgment by the user has been added, and can mean a self-evaluation performed by the user. For example, the subjective user information can include information regarding the health condition that the user feels about himself or herself, information related to the mental fitness, and etc., but are not limited thereto. For example, the subjective user information can be used to numerate information about the user such as stress, fatigue, emotional condition, and etc. And the digitized stress, fatigue, emotional condition, and etc. can be derived from the medical information related to the user.

The user information can be used as a base data deriving the medical information with high accuracy. And in the system for providing medical information according to the exemplary embodiment of the present invention, not only the objective user information is used, but also the subjective user information is used. Hence, the degree of the accuracy of derived medical information can be improved.

Meanwhile, although the user information can be directly inputted into the user terminal (10) by the user, without being restricted to this method, the information can be received at the user terminal (10) through an external network.

The result of the heath diagnoses is a result of the diagnosis inspections performed in order to understand the health conditions of the users by objectively numerating the health condition of users. It can include the numeric result values of at least one of the medical checkup items. Here, the medical checkup item, for example, can mean the factors of which the digitization is possible by being medically and popularly used, such as the total cholesterol (TC) value, the high-density lipoprotein (HDL) cholesterol value, the low-density lipoprotein (LDL) cholesterol value, etc.

In the case of the equipment in which the health diagnosis is possible, such as the body fluid analyzer whereby the user terminal (10) includes the blood according to some exemplary embodiments of the present invention, the result of the health diagnosis can include the numeric result value regarding at least one of the medical checkup item derived through the diagnosis inspection using the body fluids of the user, but is not limited thereto.

However, the result of the health diagnoses can include numeric result values on multiple medical checkup items. For example, the result can include all of the total cholesterol (TC) values, the HDL cholesterol values, and the LDL cholesterol values, but is not limited thereto.

The user terminal can include communication modules (not shown) allowing communication with the management server (20). If necessary, a mobile operational system can be installed, but is not limited thereto.

A user terminal (10), for example, can be a smartphone, a tablet PC, and etc., but is not limited thereto. And, if the device has computing capabilities, there may not be any restrictions. Except, in some exemplary embodiments of the present invention, the user terminal (10) may, for example, be an equipment with which the health diagnosis is possible like the body fluid analyzer. And, in such case, the user terminal (10) can derive the result of the health diagnosis by itself and transmit the derived results of the health diagnosis to the management server (20).

For example, the management server (20) can be a cloud server, but the type of the management server shall not be limited thereto The management server (20) can derive medical information related to the concerned user based on the information of the user received from the user terminal (10) and the results of the health diagnoses. The process of deriving the medical information shall be mentioned hereinafter. And, by transmitting the derived medical information to the user terminal (10), the management server (20) enables the user to check the medical information.

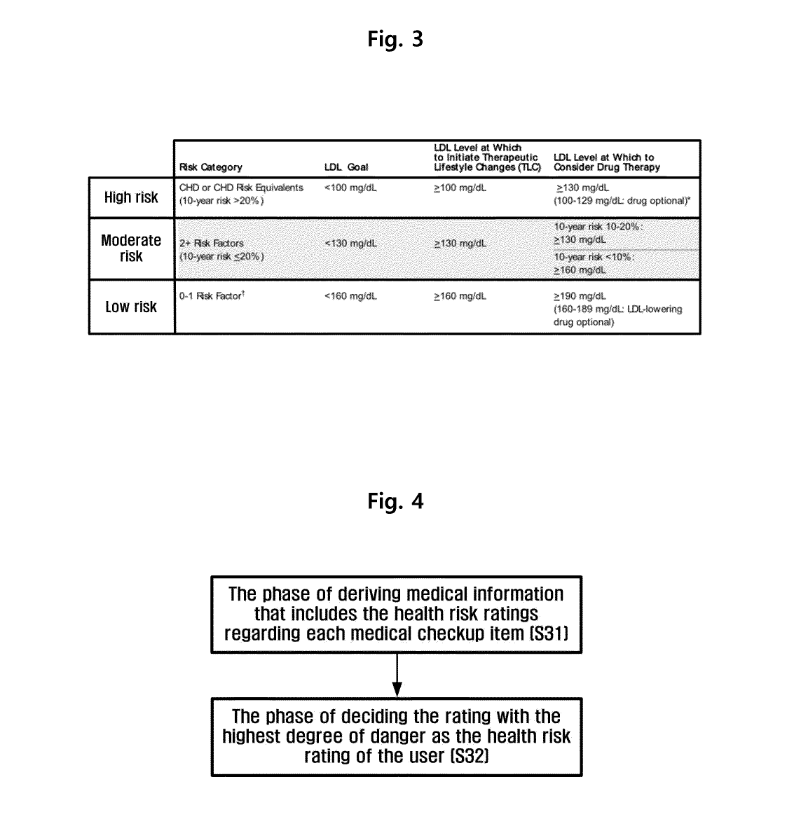

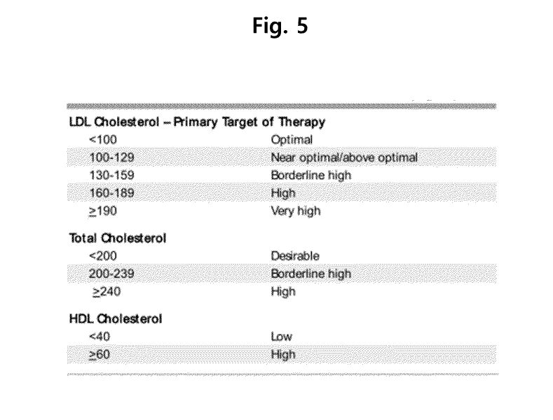

Hereinbelow, referring to FIG. 2 to FIG. 5, a method providing medical information according to the exemplary embodiment of the present invention is explained. Referring to FIG. 2, a flow chart of a method for providing medical information according to the exemplary embodiment of the present invention is disclosed, and referring to FIG. 3, a table related to the target value of the LDL cholesterol is disclosed. Referring to FIG. 4, a flow chart that has materialized the phase S30 of FIG. 2 is disclosed. Referring to FIG. 5, a table related to target values of the total cholesterol and the HDL cholesterol is disclosed. Except, since all phases illustrated in FIG. 2 may not be indispensable, methods for providing medical information may include more phases or fewer phases than the phases described herein.

Above all, referring to FIG. 2, a management server (20) may receive the user information and the result of the health diagnosis regarding the user from the user terminal (10) (S10).

Provided however, there is no need for the user information and the result of the health diagnosis regarding the user to be simultaneously received at the management server (20). And, in some exemplary embodiments, the user information and the results of the health diagnosis regarding the user can be received at the management server (20) at a different time. The definition and representative examples of the user information and the health diagnoses are as hereabove mentioned.

Subsequently, referring to FIG. 2, the management server (20) can decide the risk group in which the user belongs (S20).

Specifically, the management server (20) can decide the risk group in which the user belongs among multiple risk groups based on the user information received from the user terminal (10). Here, the multiple risk groups can be classified according to the predicted degree of danger regarding the health. For example, according to the degree of the predicted health danger, the multiple risk groups can be classified into high-risk, moderate risk, and low risk. And, based on the user information, the management server (20) can derive the degree of the predicted danger related to the health, thereby deciding the risk group in which the user belongs.

Except, as the criteria for classifying the risk group, the total number of risk groups, and etc. can be differently decided in advance according to the medical checkup item, the management server (2) can decide the risk group in which the user belongs among multiple risk groups based on the user information according to each medical checkup item. For example, regarding the first medical checkup item, the same user can pertain to a high-risk, and in the second medical checkup item, the same user may pertain to a low risk. Provided however, there may not be any classifications of the risk group according to the medical checkup item in some of exemplary embodiments. For example, referring to FIG. 3, the classification of the risk group related to the medical checkup item regarding the LDL cholesterol value is illustrated. The LDL cholesterol values, for example, can be classified into 3 risk groups: a high-risk, a moderate-risk, and a low-risk.

And, in the same way as the ATP III Guideline, as the criteria for deciding the corresponding risk group of the user is pre-determined, the management server (20) can decide the risk group in which the concerned user belongs by basing on the user information. For example, the management server (20) can confirm risk factors in relation to the age, the coronary artery disease (CHD), the family history, smoking, and etc. in the user information. When the number of the risk factors pertaining to the user is two or above, the user can be determined as belonging to a moderate risk in regards to the medical checkup item related to the LDL cholesterol value. Specifically, if one bases the basic information of ‘a 56 year old male, smoker, has no high blood pressure, has no heart disease medical history personally nor in the family’ and the user information, the concerned user has the risk factor of being a smoker and belonging in the group of age 45 years or older. Because of this, the concerned user may be determined as belonging to a moderate risk group by having two or above risk factors.

According to a method for providing medical information according to the exemplary embodiment of the present invention, as the risk group in which the user belongs is determined by using the user information, the medical information including the health risk rating can be derived more accurately in the hereinafter phase.

In addition, according to the method for providing the medical information according to the exemplary embodiment of the present invention, both the objective user information and the subjective user information can be included in the user information when deciding the risk group in which the user belongs. As such, by using the subjective user information, the degree of the accuracy of the decision regarding the risk group can be improved. As a result, the degree of the accuracy of the derived health risk rating regarding the user can be improved. Hence, reliable medical information can be provided to the user.

In the meantime, according to some exemplary embodiments, in case the management server (20) has first received the user information from the user terminal (10), the management server (20) can decide the risk group in which the user belongs before receiving the result of the health diagnosis regarding the user from the user terminal (10).

Subsequently, the management server (20) can derive the medical information which includes the health risk rating (S30).

Specifically, by considering the risk group in which the user belongs and the result of the health diagnoses regarding the user, the management server (20) can derive the medical information related to the user that includes the health risk rating. Here, the health risk rating is an index that shows the degree of the risk regarding the health condition of the user. And it can be classified into multiple health risk ratings according to the degree of the danger. For instance, the classification of the health risk rating using alphabets, such as grade A, grade B , and grade C may be possible. And the degree of the danger can be defined to gradually increase according to the order of the alphabet. As a result, although C can show that the condition is the most dangerous in terms of the health, symbols and methods showing the health risk ratings shall not be limited to this.

Such health risk ratings have been introduced so that the user can intuitively and easily understand the result of the health diagnosis regarding the user. According to a method for providing for providing medical information according to the exemplary embodiment of the present invention, the user can easily understand his or her health condition through the health risk rating.

Meanwhile, with regard to each medical checkup item, and according to each risk group, the numerical value range of resultant values pertaining to each health risk rating can be decided in advance. As a result, the management server (20) confirms the risk group in which the user belongs. And, it confirms the numerical value range of resultant values decided in each of the health risk rating in the concerned risk group. Afterwards, by confirming to which health risk rating the value of the result of the health diagnosis regarding the user pertains to, the health risk rating regarding the concerned user can be derived.

Except, as mentioned above, as the result of the health diagnoses can include the numeric result values of multiple medical checkup items, this phase (S30) can include the detailed phase (S31 and S32) as below.

Above all, regarding each of the medical checkup items, by considering the risk group in which the user belongs and the result of the health diagnosis regarding the user, the management server (20) can derive the medical information that includes the health risk ratings related to each of the medical checkup items (S31).

That is, since the results of the health diagnosis regarding multiple medical checkup items exist, regarding each of the medical checkup items, the management server (20) can derive the medical information that includes the health risk rating. Through this, multiple health risk ratings can be derived. And, for example, regarding first medical checkup item, the health risk rating is A. And, regarding the second medical checkup item, the health risk rating is C, but is not limited thereto. Specifically, referring to FIG. 5, the user in the moderate risk group showed a LDL cholesterol figure of 114, a HDL cholesterol figure of 57, a total cholesterol figure of 194, and a LDL cholesterol figure of less than 130. As such, the user's health risk rating was B, health risk rating related to the HDL figure was B, and health risk rating related to the total cholesterol figure was A with a level of less than 200.

Except, in exemplary embodiments, when deriving the medical information that includes the health risk rating regarding each of the medical checkup items, the result of the health diagnosis regarding the user may not be used as it, but may be corrected by using the subjective user information and the revised results of the health diagnosis may be used.

For example, when the user is under an extreme stress, the bio-data can significantly differ from the daily bio-data. Therefore, according to a method for providing medical information according to the exemplary embodiment of the present invention, the stress, the degree of fatigue, the emotional condition, and etc. can be numerated by using the subjective user information. And, in case the stress index, the degree of fatigue index, or the emotional condition index is high, the result of the health diagnosis, like the results of the inspection of the blood, can be corrected based on concerned indices. And, by using the corrected result of the health diagnosis, the medical information that includes the health risk ratings regarding each of the medical checkup items can be drawn.

Through this, according to a method for providing medical information according to the exemplary embodiment of the present invention, the accuracy of the derived medical information can be improved. Subsequently, the management server (20) can draw the medical information that includes the health risk ratings regarding each of the medical checkup items, and then determine the health risk rating with the highest level of danger among the derived health risk rating as the health risk rating of the user (S32).

With regard to multiple medical checkup items, the health risk rating can be decided, as with the comprehensive health risk rating. The health risk rating can be decided as that of which the degree of the danger is the highest among the derived multiple health risk ratings. For example, as mentioned above, if the health risk rating regarding the LDL cholesterol figure of the user is B, the health risk rating regarding the HDL figure is B, and the health risk rating regarding the total cholesterol figure is rated A with less than 200, and the health risk rating of the user can be decided as B. As a result, according to a method for providing medical information according to the exemplary embodiment of the present invention, if the user has a high degree of danger in any of the diagnosed items, this might alert the user of the risk.

Provided however, the derived medical information does not only include the health risk rating. It can include the description information regarding the present condition of the user, the information of the prediction regarding the future condition of the user, and the information on the recommendation for the health recovery of the user.

The description information regarding the present condition of the user can include the objective information according to the health condition of the user based on the derived health risk rating. For example, the management server (20) can indicate the description information regarding the present condition of the user, such as: ‘At present, all of your cholesterol figures are within the normal range.’

And the information of the prediction regarding the future condition of the user can include the information anticipating how the health condition of the user will change. In other words, the management server (20) refers to not only the present result of the health diagnosis regarding the user but also to the accumulated result of the health diagnoses. As such, it can track and predict enhancements of the change according to the time change and changes of the data. And, based on such prediction, the management server (20) can provide the predicted information to the user. For example, the management server (20) can draw the prediction information, such as: ‘The probability of the occurrence of a cardiovascular disease or a stroke is over 1.5 times higher than that of the normal people.’

Specifically, for the drawing of the prediction information using the accumulated result of the health diagnoses, the management server (20) can use statistical methods. For instance, the linear regression analysis method can be used. And, in case 3 or more of the accumulated results of the health diagnoses are compiled, the interpolation can be performed by using the linear recollection analysis method. As a result, values between the result of the 3 or more accumulated health diagnoses can be indirectly estimated. Through this, even if there is an empty section in terms of the time because a part of the accumulated result of the health diagnoses regarding the user has been omitted, there may not be any irrationality in the management server (20) arriving at the prediction information using the accumulated results of the health diagnoses.

And, in case 10 or more of the accumulated results of the health diagnoses is compiled, the management server (20) may perform the extrapolation by using the polynomial regression analysis method. Or, in other words, because it may be possible to find the regression solution in the direction of statistically minimizing errors, the management server (20) can derive the prediction information using the accumulated result of the health diagnoses.

In addition, in the process of drawing the prediction information regarding the future condition of the user, the management server (20) can derive the stress index, the degree of fatigue index, or the emotional condition index by using the subjective user information at the time of the results of the health diagnoses provided. Through this, by correcting or handling as an outlier the results of the health diagnosis at the concerned time, these can also be eliminated. As a result, the management server (20) can heighten the accuracy of the prediction information regarding the future condition of the user. Other than this, the recommendation information for the health recovery of the user can include the information related to the necessary measures for preventing the dangerous situations by basing on the prediction information regarding the future condition of the user as mentioned above. Or, in other words, the management server (20) can make the proposal regarding the measures of which there is the need for the users to perform, including exercising, the adjustments of the eating habits, etc. And, according to the need, a visit to the hospital can be proposed. For example, the management server (20) can derive the recommendation information, such as: ‘You need to visit the internal medicine department or the family medicine department. And, intake of the statin-affiliated drug may be necessary to adjust the cholesterol figure.’

As such, according to a method for providing medical information according to the exemplary embodiment of the present invention, the following can be additionally provided: 1. the description information regarding the present condition of the user; 2. the prediction information related to the future condition of the user; 3. the recommendation information for the recovery of the health of the user; and etc. As such, the comprehensive analysis information regarding the user can be provided.

It is clearly understandable for those having ordinary skill in the art the present invention can be embodied in various forms, other than the exemplary embodiments set forth herein, without changes in its technical idea or essential characteristic. The exemplary embodiments described herein are only for the purpose of exemplifying the present invention in all aspects, not of limiting the scope of the present invention.

1. A phase of receipt for receiving the user information and the result of the health diagnosis regarding the user, wherein the results of the health diagnosis regarding the user includes the numeric result value(s) regarding at least one medical checkup item;
a phase that decides the risk group in which the user belongs among multiple risk groups by basing on the user information, a phase that decides the risk group in which the user belongs with the multiple risk group categorized according to the degree of the danger predicted regarding the health; and,
a phase for deriving medical information related to the user that includes the health risk rating by considering the risk group in which the user belongs and the result of the health diagnosis regarding the user, a method for providing medical information that includes the phase of deriving the medical information with the figure range of the resultant value pertaining to each health risk rating has been already decided according to each risk group with regard to each medical checkup item.

2. A method for providing medical information according to claim 1, comprising:
a phase of deciding the risk group in which the user belongs is a phase to determine the phase of deciding the risk group in which the user belongs among multiple risk groups, based on the user information according to each of the medical checkup items,
a phase of deriving the medical information which includes the health risk rating by considering the risk group in which the user belongs and by considering the results of the health diagnosis regarding the user includes a phase of deriving medical information that includes the health risk ratings regarding each of the medical checkup items by considering the risk group regarding each of the medical checkup items and the results of the health diagnosis of the user.

3. A method for providing medical information according to claim 2,
wherein a phase of deriving medical information that includes the health risk rating by considering the risk group in which the user belongs and by considering the results of the health diagnosis regarding the user further includes a phase of deciding the health risk rating of which the degree of the danger is the highest among the health risk ratings derived after drawing medical information that includes the health risk rating regarding each of the medical checkup items for the health risk rating regarding the user.

4. A method for providing medical information according to claim 1,
wherein the medical information includes a statement regarding the present condition of the user, an outlook regarding the future condition of the user, and a recommendation for the recovery of the health of the user.

5. A method for providing medical information according to claim 1, comprising:
the user information includes an objective user information and a subjective user information;
the objective user information includes at least the age, the height, the weight, the gender, the brainwave condition, the medical history, the family history, and the accumulated results of the health diagnoses;
the subjective user information includes a self-evaluation information that is conducted by the user.

6. A method for providing medical information according to claim 1,
wherein the result of the health diagnoses includes numeric values on at least one medical checkup item which derived through the diagnosis inspections using the body fluid of the user.
